(19) United States
(12) Patent Application Publication
(10) Pub. No.: US 2007/0246171 A1
(43) Pub. Date: Oct. 25, 2007

(54) Window shade cutting aid

(76) Inventor: Li-Ming Cheng, Kaohsiung City (TW)

Correspondence Address: BIRCH STEWART KOLASCH & BIRCH, PO BOX 747, FALLS CHURCH, VA, 22040-0747, US

(21) Appl. No.: 11/408,948

(22) Filed: Apr. 24, 2006

(51) Int. Cl. E06B 9/00

(52) U.S. Cl. 160/178.1 R

(57) ABSTRACT

A window shade cutting aid includes a hollow sleeve consisting of a front wall, a rear wall, a top wall and a bottom wall and a ruler located on the bottom of the sleeve that has a scale for measuring length. The sleeve has a cutting slot on one side vertical to the bottom wall and running through the top wall, front wall, rear wall and bottom wall. The ruler has a recess corresponding to the cutting slot. The ruler enables users to measure the length of the cutting portion of a window shade. A cutting tool can be placed in the cutting slot to finish cutting operation of the window shade by one pass. Skewing of the side edge of the window shade after cutting can be prevented. The window shade cutting aid may be used repeatedly after the cut window shade is removed.

### FIELD OF THE INVENTION

The present invention relates to a window shade cutting aid and particularly to a cutting aid to direct a cutting tool vertically downwards during cutting a window shade.

### BACKGROUND OF THE INVENTION

A great number of window shades now on the market such as Venetian blinds, pleated window shades and the like are installed by users after purchase. During installation on the door or window, if the width of the window shade is greater than that of the door or window, the window shade has to be cut to a desired width.

FIG. 1 shows a blind which serves as an example. The window shade 1 has an upper track 11, a lower track 12 spaced from the upper track 12, a slat assembly 13 located between the upper track 11 and the lower track 12, and a lift cord control means 14 to retract the slat assembly 13 upwards or extend the slat assembly 13 downwards. During installation of the window shade 1, if the width of the upper and lower tracks 11 and 12 and the slat assembly 13 is greater than the width of the door or window, the slat assembly 13 may be retracted as shown in FIG. 2, then the length (.) of the extra portion on one side of the window shade 1 is cut off by means of a cutting tool such as a saw to make the total width of the window shade 1 to match the width of the door or window.

The cutting process mentioned above does not use any aid to guide the cutting tool. As a result, the cut window shade 1 tends to form a skew side edge as shown in FIG. 2. It spoils the total aesthetic profile of the window shade 1. The interior decoration of the house also is affected. To remedy this problem, various types of window shade cutting aids have been developed.

U.S. Pat. No. 6,865,817 B2 discloses a window shade with measurement guide. It mainly includes a hollow body with two ends communicating with each other. The body has a cutting slot extended downwards from the top side for a selected distance. When in use, a ruler sticker with a length scale is attached to an upper side of the window shade; then the window shade is retracted and held in the hollow body; finally according to the scale on the ruler sticker, a cutting tool is placed in the cutting slot to cut the widow shade vertically downwards along the cutting slot. The resulting window shade has a vertical and neater edge. While the window shade cutting aid mentioned above can facilitate cutting operation, it still has problems in practice, notably:

1. Using the cutting tool to cut the window shade along the cutting slot also cuts off the window shade cutting aid. Thus the window shade cutting aid cannot be reused. It is a waste of resources.

2. Before the window shade cutting aid is used, a ruler sticker with a length scale has to be bonded to the upper side of the window shade to be cut to facilitate measuring of the length of the cutting portion. This procedure incurs more and troublesome preparations.

3. The cutting slot has a bottom end spaced from the bottom of the window shade cutting aid at a selected distance. Hence after the cutting tool reaches the bottom end of the cutting slot, to cut off the remained portion of the window shade is unguided. The side edge of the window shade could still be skewed. Hence its practicality is not desirable.

FIG. 3 illustrates another conventional window shade cutting aid 2. It mainly includes a hollow body consisting of a front wall 21, a rear wall 22, a top wall 23 and a bottom wall 24. The hollow body has a cutting slot 25 on one side vertical to the bottom wall 24 that runs through the top wall 23, front wall 21 and rear wall 22 close to the bottom wall 24. Thereby, referring to FIGS. 4 and 5, a window shade 1 can be retracted and held in the window shade cutting aid 2, and a cutting tool 26 may be guided by the cutting slot 25 to cut the window shade 1 to form a vertical and neat side edge. While it can keep the total aesthetic profile intact and make cutting operation simpler, it also has problems as follow:

1. As shown in FIG. 5, using the cutting tool 26 to cut the window shade in the cutting slot 25 of the window shade cutting aid 2, the cutting process must be stopped when the cutting tool 26 reaches the bottom end of the cutting slot 25; then the window shade cutting aid 2 has to be removed from the window shade 1 to allow the remained portion of the window shade 1 to be cut off. The cutting operation cannot be finished by one pass. It is not convenient.

2. The window shade cutting aid 2 does not provide a measurement structure. During cutting of the window shade 1, users cannot measure precisely the length of the cutting portion. The resulting dimension of the window shade 1 after cutting could be different from the desired one. And the total width of the window shade 1 could be not matching the width of the door or window.

### SUMMARY OF THE INVENTION

Therefore the primary object of the present invention is to provide a window shade cutting aid to overcome the problems of the conventional window shade cutting aids such as not able to be used repetitively, inconvenient, not able to finish cutting in one process, not practical measuring means and the like. The invention aims to provide a smoother cutting operation for window shades.

To achieve the foregoing objects, the window shade cutting aid of the invention mainly includes a hollow sleeve consisting of a front wall, a rear wall, a top wall and a bottom wall, and a ruler located on the bottom of the sleeve. The hollow sleeve has a cutting slot on one side vertical to the bottom wall. The cutting slot is extended downwards from the top wall and front wall and rear wall and runs through the bottom wall. The ruler has a recess corresponding to the cutting slot and a scale on the top surface for measuring length.

The structure of the invention set forth above can achieve the following effects:

1. Cutting of the window shade is convenient: As the cutting slot is extended to the recess of the ruler, the cutting tool can be moved from top to bottom by one pass to cut off the window shade until reaching the recess. Hence cutting operation is more convenient.

2. Able to measure the length: Before cutting the window shade, the dimension of the portion to be cut off can be measured through the ruler to prevent the length of the cut window from unfitting to the width of the door or window.

3. Usable repetitively: The cutting operation is finished when the cutting tool reaches the recess of the ruler. Then the cut window shade can be removed, and the window shade cutting aid can be reused repetitively.

4. The cut window shade has a neat and vertical side edge: As the cutting slot is vertical to the bottom wall, it provides an excellent guiding effect for the cutting tool and can prevent skewing of the side edge of the window shade after the cutting operation is finished.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional window shade.

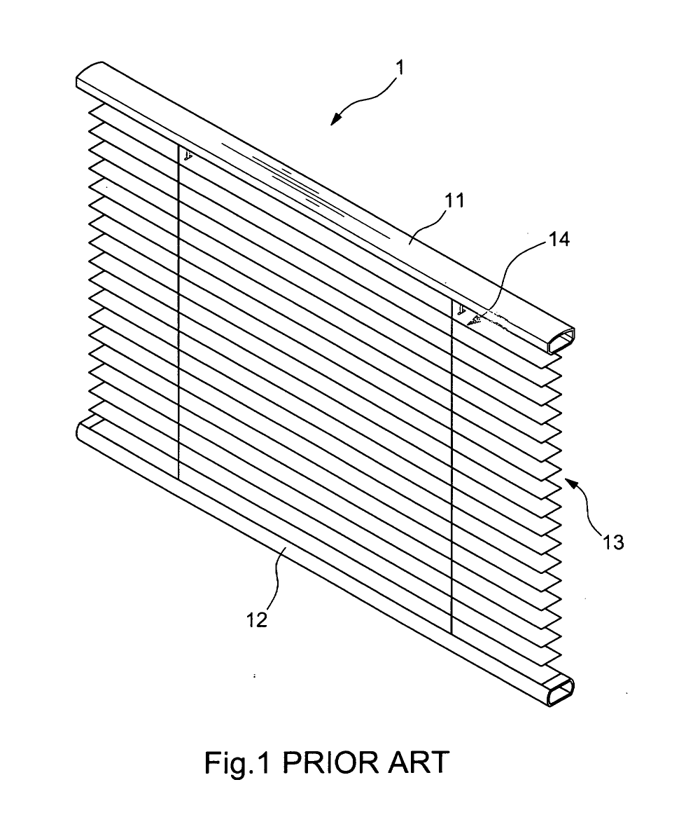

FIG. 2 is a front view of a conventional window shade after being cut.

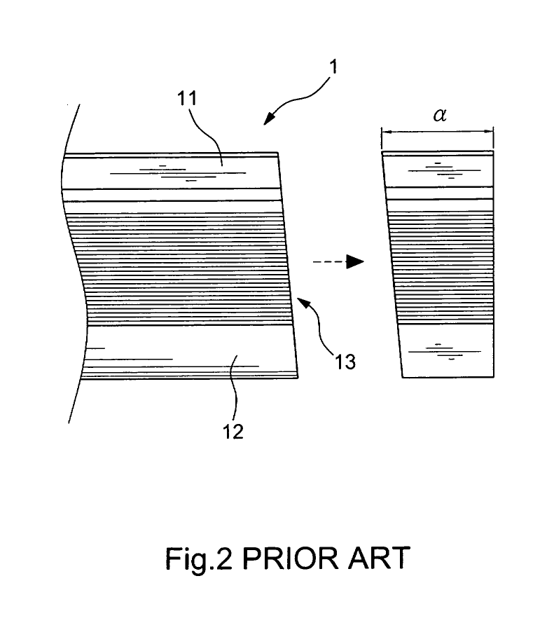

FIG. 3 is a perspective view of a conventional window shade cutting aid.

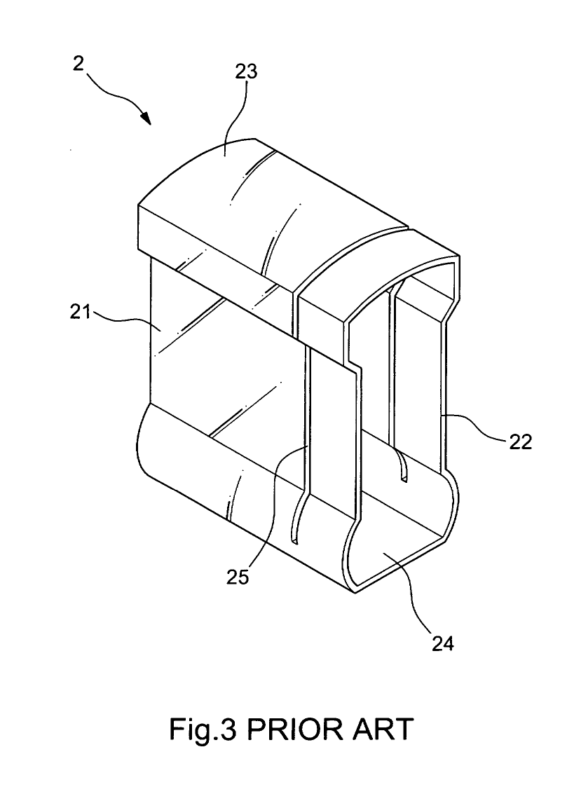

FIG. 4 is a schematic view of a conventional window shade cutting aid in an operating condition.

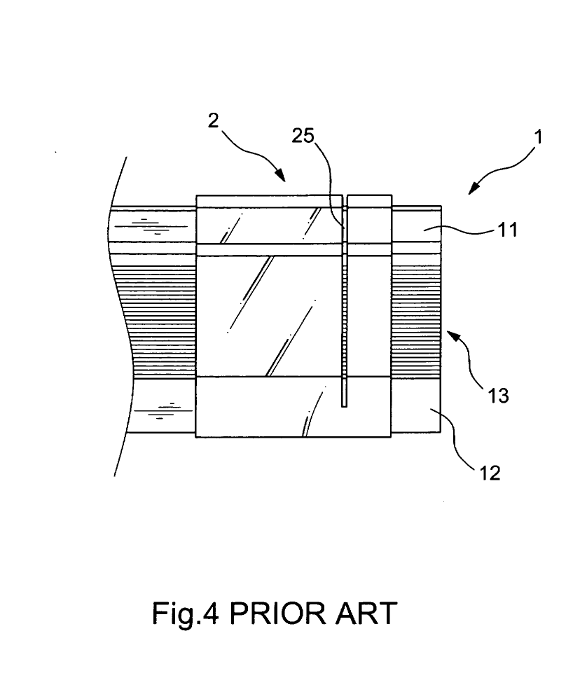

FIG. 5 is a schematic view of a conventional window shade cutting aid in another operating condition.

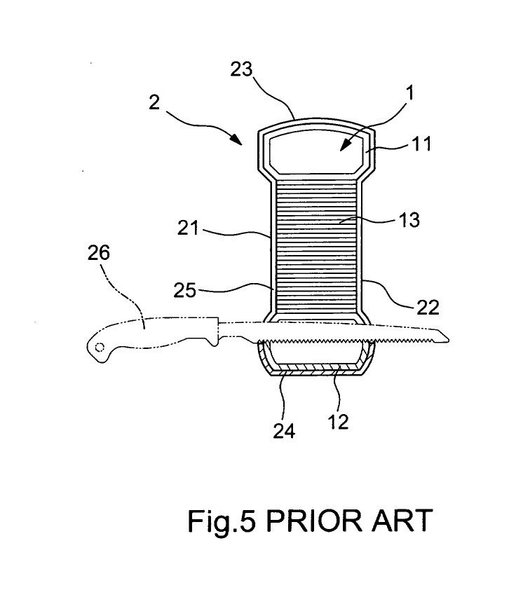

FIG. 6 is a perspective view of the window shade cutting aid of the present invention.

FIG. 7 is a schematic view of the window shade cutting aid of the present invention in operating condition-1.

FIG. 8 is a schematic view of the window shade cutting aid of the present invention in operating condition-2.

FIG. 9 is a schematic view of the window shade cutting aid of the present invention in operating condition-3.

FIG. 10 is a perspective view of another embodiment of the window shade cutting aid of the present invention.

FIG. 11 is a perspective view of yet another embodiment of the window shade cutting aid of the present invention.

FIG. 12 is a perspective view of still another embodiment of the window shade cutting aid of the present invention.

### DETAILED DESCRIPTION OF THE PREFERRED EMBODIMENTS

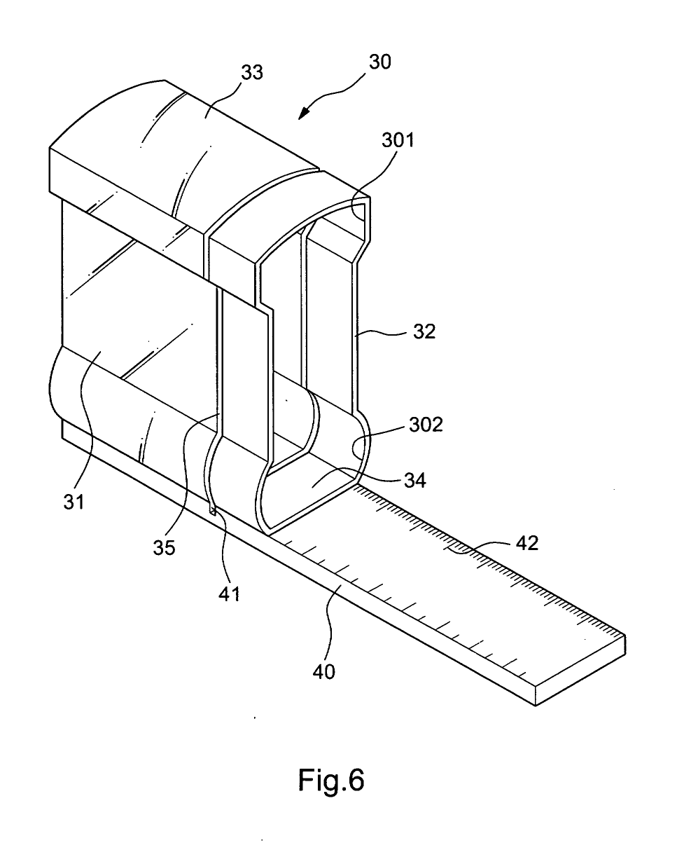

Please refer to FIG. 6, the window shade cutting aid according to the invention includes a hollow sleeve 30 consisting of a front wall 31, a rear wall 32, a top wall 33 and a bottom wall 34, and a ruler 40 located on the bottom of the sleeve 30. The sleeve 30 has a cutting slot 35 on one side vertical to the bottom wall 34 that runs through the top wall 33, front wall 31, rear wall 32 and bottom wall 34. The ruler 40 has a recess 41 corresponding to the cutting slot 35. The ruler 40 has a scale 42 on the top surface for measuring length.

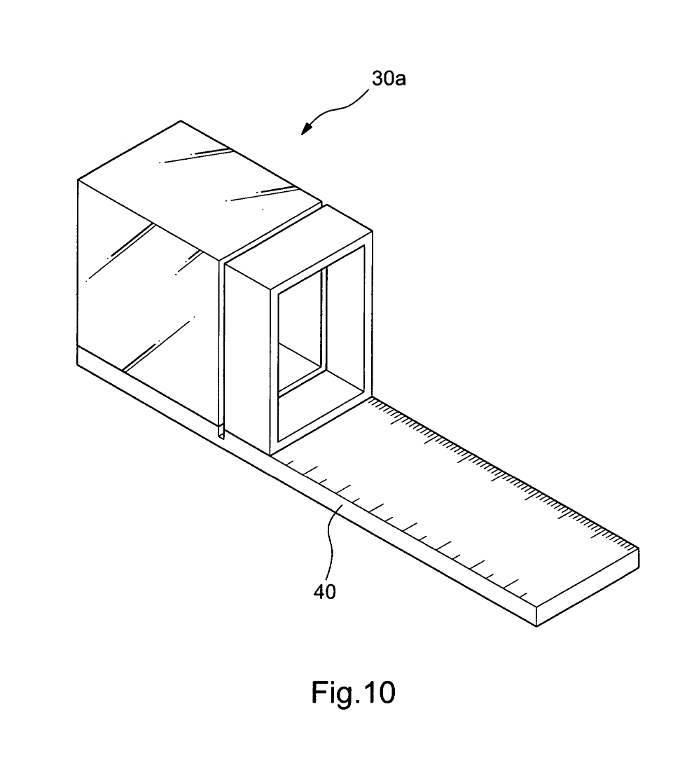

The hollow sleeve 30 is formed in various shapes to mate different profiles of window shapes on the market (the profiles means the geometric shapes of the window shade after retracted). FIG. 6 shows an example in which the hollow sleeve 30 has an expanded first holding portion 301 adjacent to the top wall 33 and an expanded second holding portion 302 adjacent to the bottom wall 34 to hold a window shade which has a larger upper track and a larger lower track. FIG. 10 illustrates another example in which the hollow sleeve 30a is rectangular to hold a window shade which is substantially rectangular after retracted. Hence the window shade cutting aid of the invention is applicable widely.

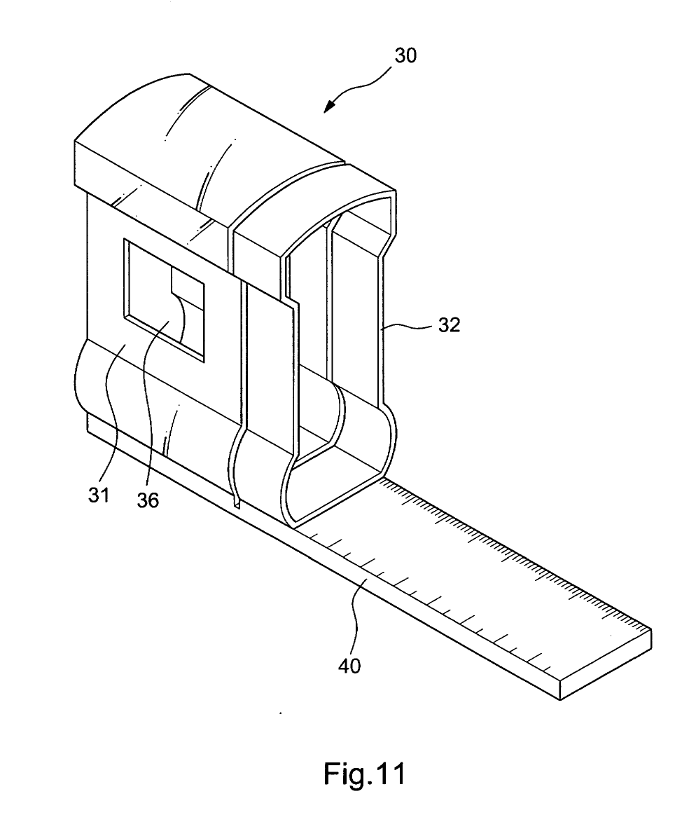

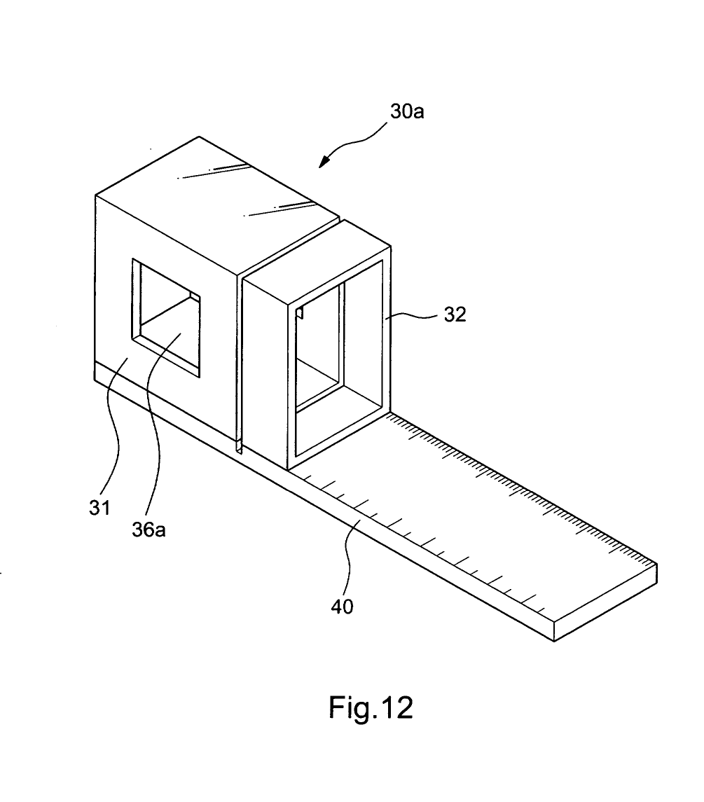

Refer to FIG. 11 for yet another embodiment of the invention. Aside from the sleeve 30 which has an expanded first holding portion 301 and second holding portion 302, the front wall 31 and the rear wall 32 have respectively an opening 36. Refer to FIG. 12 for still another embodiment of the invention in which the front wall 31 and rear wall 32 of the rectangular hollow sleeve 30a have respectively an opening 36a formed thereon. Hence when the window shade cutting aid is in use for cutting a window shade, user's hand can hold two sides of the cutting window shade through the openings 36 or 36a to facilitate cutting operation.

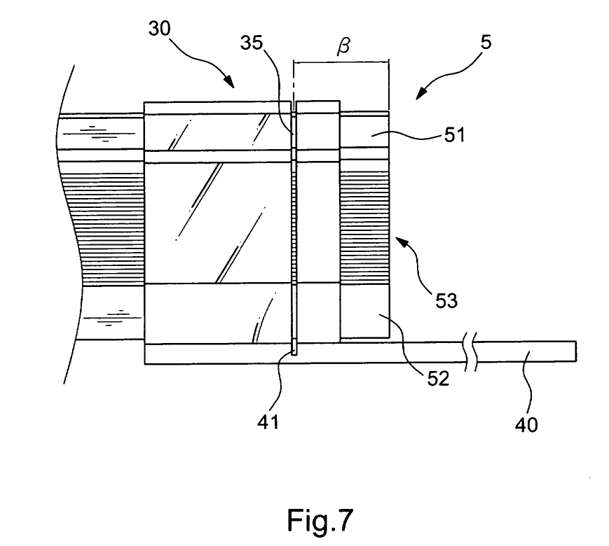

Refer to FIG. 7, the window shade cutting aid of the invention mainly aims to cut a window shade 5 which has an upper track 51, a lower track 52 and a slat assembly 53 such as a Venetian blind, a pleated window shade or the like. Details of use conditions are discussed below:

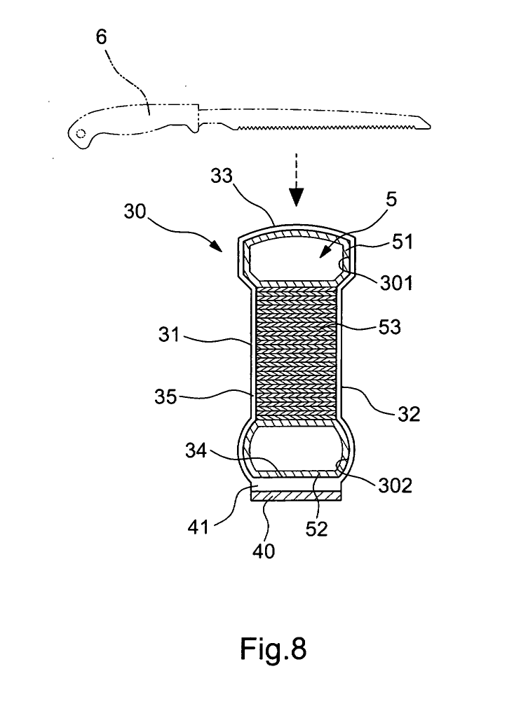

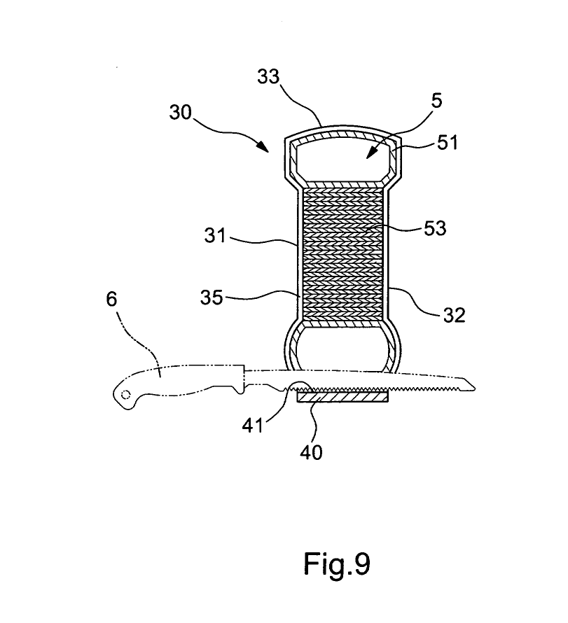

Referring to FIGS. 6 and 7, first, the slat assembly 53 of the window shade 5 to be cut is retracted; next, encase the window shade 5 in the sleeve 30; measure the length (.) on one side of the window shade 5 to be cut off through the scale 42 on the top surface of the ruler 40; then as shown in FIGS. 8 and 9, place a cutting tool 6 such as a saw or the like in the cutting slot 35 with one hand holding the top wall 33 of the sleeve 30 and other hand grasping the cutting tool 6; slit the upper track 51, slat assembly 53 and lower track 52 in this order from up to down until the cutting tool 6 reaching the recess 41 of the ruler 40 to finish cutting operation of the window shade 5. Such an approach gives the cutting tool 6 an excellent guide for downward cutting operation. The cut window shade 5 has a neater and smoother side edge and skewing is less likely to occur. Thus the entire window shade 5 is more appealing. The width of the cut window shade 5 also can fit the width of the door or window nicely.

Based on previous discussion, the window shade cutting aid of the invention has the following features:

1. The cutting slot 35 of the sleeve 30 is extended to the recess 41 of the ruler 40, hence when the window shade 5 is encased in the sleeve 30 and the cutting tool 6 is placed in the cutting slot 35 to do cutting operation, the cutting operation can be finished by one pass of the cutting tool 6. The cutting operation of the window shade 5 is faster and simpler.

2. The ruler 40 attached to the window shade cutting aid enables users to measure in advance the length (.) of the cutting portion on one side of the window shade 5 according to the scale 42 formed thereon (including the distance from the cutting slot 35 to the edge of the sleeve 30). The dimension of the cut window shade 5 can better fit the width of the door or window.

3. After finishing the cutting operation of the window shade 5, the window shade cutting aid is intact without being cut off and can be used repeatedly. Its practicality improves.

4. The cutting aid covers the window shade 5 from the outer side, and the cutting tool 6 performs cutting operation in the cutting slot 35. Moreover, the cutting slot 35 is vertical to the bottom wall 34. Hence it gives the cutting tool 6 an excellent guide during cutting operation downwards. The cut window shade 5 has a neater and smoother side edge and skewing is less likely to occur.

In short, the window shade cutting aid of the invention can finish cutting operation of the window shade 5 by one pass. The length of the cut window shade 5 can fit the width of the door or window precisely, and the side edge is vertical and neater. It also can be used repeatedly. It greatly enhances the convenience of cutting operation of the window shade 5.

What is claimed is:

1. A window shade cutting aid comprising a hollow sleeve which includes a front wall, a rear wall, a top wall and a bottom wall and a ruler located on the bottom of the sleeve, the sleeve having a cutting slot on one side vertical to the bottom wall, the cutting slot running through the top wall, the front wall, the rear wall and the bottom wall, the ruler having a recess corresponding to the cutting slot and a scale on the top surface for measuring length.

2. The window shade cutting aid of claim 1, wherein the hollow sleeve has an expanded first holding portion adjacent to the top wall and an expanded second holding portion adjacent to the bottom wall.

3. The window shade cutting aid of claim 2, wherein the front wall and the rear wall of the hollow sleeve have respectively an opening.

4. The window shade cutting aid of claim 1, wherein the hollow sleeve is rectangular.

5. The window shade cutting aid of claim 4, wherein the front wall and the rear wall of the hollow sleeve have respectively an opening.
